(19) United States
(12) Patent Application Publication
(10) Pub. No.: US 2017/0009839 A1
(43) Pub. Date: Jan. 12, 2017

(54) Vibration Damper, And Piston Valve For A Vibration Damper

(71) Applicant: ZF Friedrichshafen AG, Friedrichshafen (DE)

(72) Inventors: Helmut BAALMANN, Bergrheinfeld (DE); Hassan ASADI, Schweinfurt (DE); Hans GONSCHORREK, Bergrheinfeld (DE); Lothar KRILL, Eitorf (DE); Alexander KRUSE, Werneck (DE); Oswald LICHTLEIN, Bergtheim (DE); Dirk LITTERSCHEID, Eitorf (DE); Thomas MANGER, Wasserlosen (DE); Harun TUCOVIC, Schweinfurt (DE); Heinz SYDEKUM, Dittelbrunn (DE)

(73) Assignee: ZF Friedrichshafen AG, Friedrichshafen (DE)

(21) Appl. No.: 15/114,147

(22) PCT Filed: Dec. 17, 2014
(86) PCT No.: PCT/EP2014/078149

§ 371 Date: Jul. 26, 2016

(30) Foreign Application Priority Data
Jan. 28, 2014 (DE) 10 2014 201 481.6

(51) Int. Cl. F16F 9/348; F16F 9/32

(52) U.S. Cl. CPC F16F 9/3485; F16F 9/3214; F16F 9/3488; F16F 2226/04; F16F 2230/0082

(57) ABSTRACT

A vibration damper includes a piston rod (2) which transitions into a piston rod neck (4) while forming a contact shoulder (6) and guides a piston valve (1) at this piston rod neck (4), this piston valve (1) is pretensioned against the contact shoulder (6) of the piston rod (2). To reduce variances in damping force in batch fabrication of the vibration damper, a compensating disk (20) is fitted axially between the contact shoulder (6) and the piston valve (1), which compensating disk (20) is produced from a material with a lower yield strength compared to the piston rod (2) and/or compared to an immediately succeeding component of the piston valve (1).

### PRIORITY CLAIM

This is a U.S. national stage of application No. PCT/EP2014/078149, filed on Dec. 17, 2014. Priority is claimed on the following applications: Country: Germany, Application No.: 10 2014 201 481.6, Filed: Jan. 28, 2014, the content of which is incorporated herein by reference in its entirety.

### FIELD OF THE INVENTION

The invention is directed to a vibration damper comprising a piston rod which transitions into a piston rod neck while forming a contact shoulder and guides a piston valve at this piston rod neck, this piston valve being pretensioned against the contact shoulder of the piston rod. The invention is further directed to a piston valve for a vibration damper comprising a piston body which is placed axially between supporting disks.

### BACKGROUND OF THE INVENTION

In motor vehicles, vibration dampers are mostly applied in the form of hydraulic-mechanical dampers, particularly between a respective vehicle body and the axles of the respective motor vehicle. At these locations, a vibration damper serves on the one hand to prevent rocking and after-vibration of the vehicle body when excited by the roadway or in certain vehicle states and, on the other hand, to ensure rapid attenuation of a vibration that is excited in a vehicle wheel by the roadway. In the latter case, road grip of this vehicle wheel is always guaranteed.

Vibration dampers are commonly constructed as telescoping shock absorbers in the form of mono-tube dampers or twin-tube dampers. A damping action is achieved through the displacement of a damping medium, usually in the form of a hydraulic fluid. This displacement takes place via a piston valve which is outfitted with, usually, a plurality of passages for the damping medium. In order to define the characteristic curves of the vibration damper, the flow of the damping medium is subjected to resistance which frequently takes the form of valve disks which are pretensioned against a valve seat and which cover orifices of the passages until a defined pressure is reached. However, to prevent variances of damping force in case of batch fabrication of vibration dampers, a constant defined pretensioning of the valve disks must always be ensured in the course of assembly.

WO2012/031805 shows a vibration damper in which a piston rod guides a piston valve at an end-side piston rod neck. The piston valve is pretensioned by means of a fastening nut against a contact shoulder of the piston rod which is formed in the transition from an outer diameter of the piston rod to the piston rod neck. The piston valve comprises a piston body which is axially pierced by passages whose respective orifice can be covered via valve disks. The piston body, together with the valve disks, is then placed axially between supporting disks inside the piston valve.

Taking the above-described prior art as a point of departure, it is an object of the present invention to provide a vibration damper, or a piston valve for a vibration damper, via which variances in damping force can be mitigated in batch fabrication of the vibration damper.

Accordingly, a vibration damper comprises a piston rod which transitions into a piston rod neck while forming a contact shoulder and which guides a piston valve at this piston rod neck. The piston valve is then pretensioned against the contact shoulder of the piston rod. Within the meaning of the invention, the piston rod neck is formed at an axial end of the piston rod and is provided with an external thread at the axial end side, and a fastening nut having an internal thread can be fitted on this external thread in order to pretension the piston valve against the contact shoulder. The contact shoulder is defined by a step along which the piston rod decreases from a previous outer diameter to the outer diameter of the piston rod neck. To this extent, the contact shoulder is in the form of a substantially axial, annular contact face for the piston valve.

According to the invention, “axial” means an orientation in direction of a longitudinal central axis of the piston rod or piston valve. In contrast, “radial” means an orientation in direction of a radius of the piston rod or piston valve.

According to the invention a compensating disk is fitted axially between the contact shoulder of the piston rod and the piston valve, which compensating disk is produced from a material with a lower yield strength compared to the piston rod and/or compared to an immediately succeeding component of the piston valve. In other words, a compensating disk is provided in axial direction between the contact shoulder of the piston rod and the piston valve, the material of this compensating disk being weaker with respect to yield strength than the material of the piston rod and/or than the material of a component of the piston valve immediately adjacent to the compensating disk.

This kind of arrangement of a vibration damper has the advantage that variances in damping force caused by production-dependent shape deviations of the contact shoulder can be mitigated in batch fabrication of the vibration damper. Ideally, an angle defined by the piston rod neck and the contact shoulder is exactly 90°, where deviations from this ideal angle may occur due to tolerances. An angle greater than 90° has the disadvantage that high stresses can occur in the support region of the piston valve at the contact shoulder due to pretensioning of the piston valve against the contact shoulder, and preload losses can occur subsequently. On the other hand, an angle of less than 90° leads to an increased pretensioning of the piston valve, particularly of valve disks thereof, which can result in impaired functioning of the piston valve. In both cases, the damping force deviates from a desired damping force at the ideal angle of 90°, which leads to deviating damping forces between the finished vibration dampers produced in batch fabrication.

Now when a compensating disk made of a material with lower yield strength is provided between the contact shoulder and piston valve as is suggested by the invention, this compensating disk contacts the contact shoulder, and possibly also the immediately succeeding component part of the piston valve, in a positive engagement when a pretensioning is carried out in excess of the yield strength of the compensating disk. Accordingly, the compensating disk compensates the above-mentioned, tolerance-dependent angular deviation of the contact shoulder.

In contrast, the piston valve in DE 10 2010 040 458 A1 is pretensioned directly against the contact shoulder of the piston rod so that the above-mentioned problems can occur when the angle defined between the contact shoulder and the piston rod neck deviates from the ideal angle (90°). To this extent, unavoidable tolerance-dependent shape deviations of the contact shoulder would lead to damping force variances in batch fabrication.

According to the invention, “yield strength” refers particularly to a yield point of a material in the compression direction and/or tension direction. This relates to a stress which occurs under tensile loading and/or compressive loading and beyond which the material starts to deform plastically. But beyond this, the material of the compensating disk can be constructed so as to be weaker in general with respect to yield point than that of the piston rod and/or then that of the adjacent component of the piston valve. In this case, that is, a bending yield and a torsional yield of the material of the compensating disk would also be less than that of the material of the piston rod and/or of the material of the immediately succeeding component of the piston valve.

Within the meaning of the invention, the yield strength of the material of the compensating disk is selected to be lower at least than that of the material of the piston rod, but at the same time it can also be lower than a yield strength of the material of the immediately succeeding component of the piston valve. However, what is important in this regard is the ratio with respect to the material of the piston rod and at least the material of the piston rod selected in the region of the contact shoulder because it would otherwise be impossible for the compensating disk to plastically contact the contact shoulder in a positive engagement accompanied by compensation of shape deviations thereof. If, in addition, the yield strength of the material of the compensating disk is selected to be smaller than that of the material of the immediately succeeding component of the piston valve, the positive-engagement contact of the compensating disk will be further improved.

A vibration damper according to the invention is preferably assembled in that initially the compensating disk and at least the immediately succeeding component of the piston valve are slid onto the piston rod neck of the piston rod against the contact shoulder and subsequently tensioned with preload against the contact shoulder. This preload lies above a subsequent assembly pretensioning force. Subsequently, the entire piston valve is fastened to the piston rod neck accompanied by pretensioning with the assembly pretensioning force. Thus within the meaning of the invention, at least the component of the piston valve immediately succeeding the compensating disk is slid onto the piston rod neck during pretensioning with the preload and is subsequently pretensioned together with the compensating disk against the contact shoulder. However, a plurality of components of the piston valve, or also the entire valve, can be arranged on the neck during this pretensioning. Further, the subsequent pretensioning and fastening of the piston valve to the piston rod neck with the assembly pretensioning force is carried out in particular by means of a fastening nut which is guided for this purpose by an internal thread on an external thread of the piston rod neck.

Alternatively, or also in addition to the above described embodiment, the above-stated object is met through an arrangement of a piston valve for a vibration damper which comprises a piston body which is placed axially between supporting disks. The invention additionally includes the technical teaching that at least one of the supporting disks on an axial side facing the piston body is constructed so as to be at least partially concavely curved, while the piston body is convexly curved at least partially at each axial side facing this at least one supporting disk.

In other words, at least one of the supporting disks is outfitted on the piston body side with a concave curvature which extends in radial direction at least over a portion of this supporting disk. The piston body likewise has a curvature on a side facing this at least one supporting disk; but this curvature is shaped convexly and extends at least over a portion of the radial extension of the piston body.

The advantage in arranging a piston valve in this way consists in that a pretensioning of interposed valve disks against a valve seat at the piston body is increased owing to the shielding defined by the curvatures of the at least one supporting disk and of the piston body. Because of this higher pretensioning of the valve disks, damping force variances between individual fabricated piston valves, and therefore also vibration dampers, can be avoided in batch fabrication.

However, in the prior art, the supporting disks and also the piston body of the piston valve are constructed with surfaces which extend in straight lines in radial direction. Consequently, owing to the shape of the supporting disks and piston body, there is no increase in a pretensioning of the valve disks at a valve seat formed at the piston body so that insufficient pretensionings of the valve disks and, therefore, damping force variances can come about in batch fabrication of the piston valve.

In a further development of the invention, the piston body is axially penetrated by at least one passage which can be covered via at least one valve disk at each orifice. The flow of a damping medium, particularly in the form of hydraulic fluid, can be influenced by means of this type of arrangement of a piston valve.

A combination of the above described embodiments can also be carried out. To this extent, this vibration damper has a compensating disk fitting between the contact shoulder and piston valve and has at least one curved supporting disk and a curved piston body in the region of its piston valve.

As an alternative, a piston valve of the vibration damper can also be configured in such a way that it includes a piston body through which at least one passage extends axially. The at least one passage can be covered at each orifice via at least one valve disk, the piston body and the at least one valve disk being placed between supporting disks on the piston rod neck. In this case, the supporting disks and the piston body of the piston valve are constructed without curvatures.

In a further development of the invention, the at least one passage can be covered at each orifice via a valve disk package; that is, a plurality of axially successive valve disks are provided in the region of the orifice of the at least one passage. According to a further construction, the at least one valve disk contacts an intermediate disk on a side remote of the piston body, which intermediate disk extends radially over a portion of the at least one valve disk. By this intermediate dusk, a defined bending of the at least one valve disk can be realized. In case of a valve disk package, the valve disk of the package axially outward of the piston body contacts this intermediate disk.

The invention is not limited to the combination of features specified in the independent claim or the claims depending on the latter. Further, there are possibilities for combining individual features also insofar as they follow from the claims, the following description of preferred embodiment forms or directly from the drawings. The referencing of the claims to the drawings through the use of reference numbers shall not limit the protective scope of the claims.

### BRIEF DESCRIPTION OF THE DRAWINGS

Advantageous embodiments of the invention are described in the following and shown in the drawings in which:

FIG. 1 is a sectional view of a part of a vibration damper according to a preferred embodiment form of the invention shown in the region of a piston valve;

FIG. 2 is a view of a detail Z from FIG. 1; and

FIG. 3 is a sectional view of a vibration damper in the region of a piston valve which is realized in accordance with a preferred configuration of the invention.

### DETAILED DESCRIPTION OF THE PRESENTLY PREFERRED EMBODIMENTS

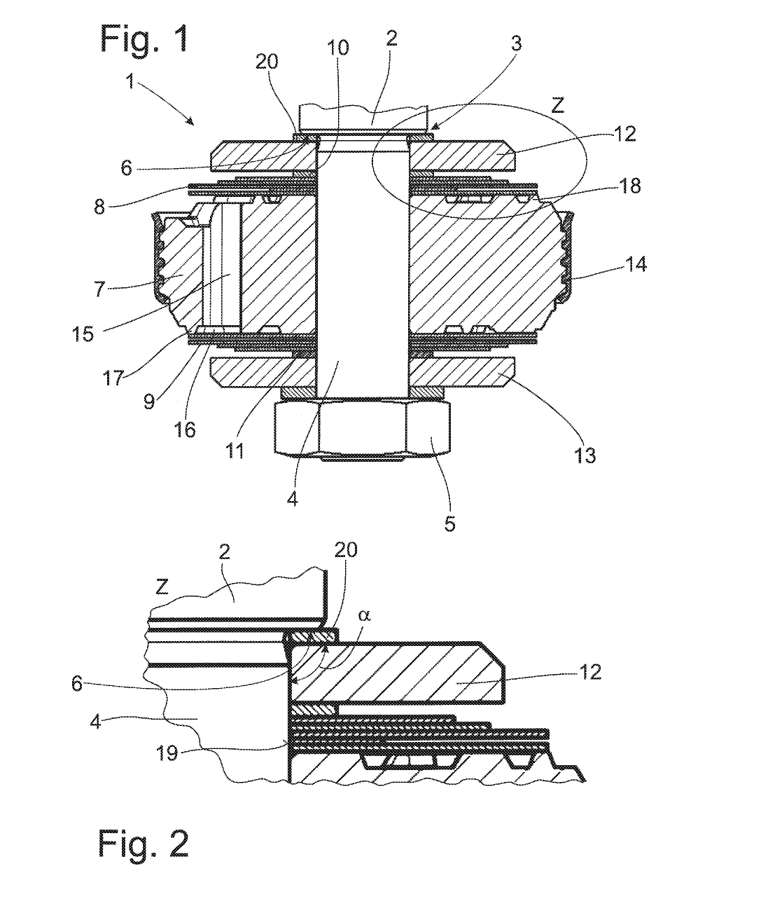

FIG. 1 shows a sectional view of a portion of a vibration damper according to a preferred embodiment form of the invention which is shown in the region of a piston valve 1. Part of a piston rod 2 of the vibration damper can be seen. The outer diameter of this piston rod 2 decreases at the axial end via a step 3 to a piston rod neck 4. The piston rod 2 carries the piston valve 1 at this piston rod neck 4, the piston valve 1 being pretensioned against a contact shoulder 6 of the piston rod 2 via a fastening nut 5. This contact shoulder 6 is defined through step 3 and is provided as a substantially axially oriented annular contact surface.

The fastening nut 5 is fitted by an internal thread—not shown further—to a corresponding external thread of the piston rod neck 4 and pretensions the piston valve against the contact shoulder 6. The piston valve comprises a plurality of components in the form of a piston body 7, valve disk packages 8 and 9, associated intermediate disks 10 and 11, and two supporting disks 12 and 13.

As can further be seen from FIG. 1, the piston body 7 carries a seal 14 at an outer diameter. The piston body 7 makes contact with a circumferential cylindrical tube—not shown in more detail—of the vibration damper via this seal 14 which serves to seal a gap between the piston body 7 and cylindrical tube. Further, the piston body 7 is axially penetrated by a plurality of passages, of which only one passage 15 is visible in the section plane of FIG. 1, which allow a damping medium to pass between spaces of the vibration damper which are separated from one another by the piston body 7.

Over the course of the in-and-out movements of the piston rod 2 and, therefore, also of the piston body 7, there is a displacement of the damping medium between the separate spaces of the vibration damper. The damping medium is displaced through the passages 15 of the piston body 7 from one space to the other. The passages are covered in the region of their orifices, which are oriented toward each axial side of the piston body 7, via the valve disk package 8 and 9, respectively, at that location. In the case of orifice 16 of passage 15, this is valve disk package 9.

The respective orifice is released only after a certain pressure has been reached in the associated passages, which pressure is sufficient to lift the respective valve disk package 8 and 9, respectively, from an associated valve disk 17 and 18, respectively. Accordingly, the valve disk packages 8 and 9, respectively, influence the flow of the damping medium via the passages and subject it to resistance.

A defined bending of the individual valve disks of the valve disk packages 8 and 9 is realized by the associated intermediate disk 10 and 11, respectively, which additionally axially contacts the outermost valve disk of the respective valve disk package 8 and 9, respectively, for this purpose and overlaps the latter radially with the valve disks, after which the bending is to take place.

However, the configuration of the step 3 of the piston rod 2 and, therefore, the definition of the contact shoulder 6 are subject to tolerances related to manufacture which can result in shape deviations of the contact shoulder 6 in batch fabrication of the vibration damper. In particular, an angle a can have deviations, which angle a, as is shown by detail Z in FIG. 2, is defined by an outer diameter 19 of the piston rod neck 4 and the contact shoulder 6. Ideally, this angle a is exactly 90° so that an exactly axially oriented contact surface is defined for the piston valve 1. However, in the course of tolerance-dependent shape deviations, angle a can also be greater than or less than 90°, which would result in loss of preload in the first case and in an increased pretensioning of the valve disk packages 8 and 9 in the second case.

In order to compensate for the above-mentioned tolerance-dependent shape deviations of the contact shoulder 6, the vibration damper according to the invention has as a special feature a compensating disk 20 which is fitted on the piston rod neck 4 axially between the piston valve 1 and contact shoulder 6. This compensating disk 20 is produced from a material having a lower yield strength than the material of the piston rod 2 and also of the immediately adjacent component of the piston valve 1 in the form of the supporting disk 12. As a result, the compensating disk 20 deforms plastically when a defined preload is applied and contacts the contact shoulder 6 and supporting disk 12 in positive engagement so that shape deviations are compensated.

To assemble the piston valve 1 on the piston rod 2, the compensating disk 20 and supporting disk 12 are first slid on the piston rod neck 4 and subsequently pretensioned with the preload against the contact shoulder 6 so that the above-mentioned plastic deformation of the compensating disk 20 occurs. Subsequently, the remaining components of the piston valve 1 are also guided on the piston rod neck 4 and pretensioned against the contact shoulder 6 by means of the fastening nut 5 by applying an assembly pretensioning force, i.e., a defined tightening torque of the nut, this assembly pretensioning force being smaller than the preload for the plastic deformation of the compensating disk 20.

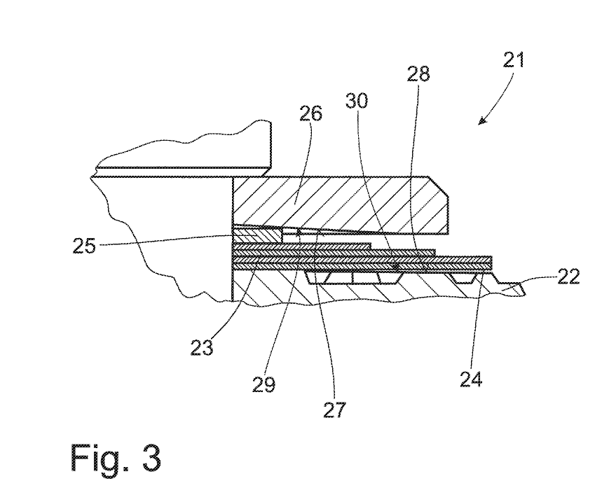

FIG. 3 shows a sectional view of a part of a vibration damper in the region of a piston valve 21 which is realized according to a preferred embodiment of the invention. This piston valve 21 comprises a piston body 22 which is axially penetrated—not shown—by at least one passage. An orifice of this passage is covered via a valve disk package 23 which is pretensioned against an associated valve seat 24 of piston body 22.

The valve disk package 23 releases the respective orifice of the respective passage after reaching a certain pressure in the passage, wherein a defined bending of the valve disks of the valve disk package 23 is shown via an axially adjacent intermediate disk 25. This intermediate disk 25 extends radially to the extent beyond which the desired bending of the valve disks of the valve disk package 23 is to take place.

A corresponding valve disk package and an associated intermediate disk are preferably provided on the opposite axial side of the piston body 22 which is not shown in FIG. 3. All of the components which are accordingly provided are received axially between two supporting disks, of which only supporting disk 26 is shown in FIG. 3.

To increase a pretensioning of the valve disks of the valve disk package 23 against the valve seat 24 and, accordingly, to reduce the risk of damping force variances in batch fabrication of the piston valve 21, the supporting disk 26 and the piston body 22 are outfitted with curvatures 29 and 30, respectively, on facing sides 27 and 28. The concave curvature 29 extends from an inner diameter of the supporting disk 26 radially along a portion of the side 27, while the convex curvature 30 is carried out along the entire radial extension of the side 28 of the piston body 22. Since consequently the contact surfaces for the valve disks of the valve disk package 23 and of the intermediate disk 25 are also not axial but are curved, the pretensioning of the valve disks of the valve disk package 23 against the valve seats 24 is ultimately increased.

Consequently, damping force variances in batch fabrication can be appreciably reduced by means of the configuration according to the invention of a vibration damper and a piston valve.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-10. (canceled)

11. A vibration damper comprising:
a piston valve (1);
a piston rod (2) having a piston rod neck (4) for carrying said piston valve (1);
a contact shoulder (6) between said piston rod (2) and said piston rod neck (4); said piston valve (1) being pretensioned against said contact shoulder (6) of said piston rod (2);
a compensating disk (20) fitted axially between said contact shoulder (6) and said piston valve (1), said compensating disk constructed from a material having a lower yield strength than a material forming said piston rod (2) and/or a material forming a component of said piston valve (1) immediately succeeding said piston rod (2).

12. The vibration damper according to claim 1, wherein said piston valve (1) comprises a piston body (7) having at least one passage (15) extending axially therethrough, said at least one passage (15) having an orifice (16); wherein said at least one passage (15) can be covered at each said orifice (16) with at least one valve disk, and wherein said piston body (7) and said at least one valve disk are placed between supporting disks (12, 13) on said piston rod neck (4).

13. The vibration damper according to claim 12, wherein said at least one passage (15) can be covered at each said orifice (16) with a valve disk package (9).

14. The vibration damper according to claim 12, additionally comprising an intermediate disk, and wherein said at least one valve disk contacts said intermediate disk (10; 11) on a side remote of said piston body (7), said intermediate disk (10; 11) extending radially over a portion of said at least one valve disk.

15. The vibration damper according to claim 11, wherein said piston valve (1) is a piston valve according to claim 18.

16. A method of assembling a vibration damper according to claim 11, comprising: initially sliding the compensating disk (20) and at least the immediately succeeding component of the piston valve (1) onto the piston rod neck (4) of the piston rod (2) against the contact shoulder (6);
subsequently tensioning the compensating disk (20) and the at last immediately succeeding component of the piston valve (11) with a preload against the contact shoulder (6), the preload being above a subsequent assembly pretensioning force; and
fastening the complete piston valve (1) to the piston rod neck (4) accompanied by pretensioning with the assembly pretensioning force.

17. A piston valve (21) for a vibration damper comprising:
a piston body (22) placed axially between supporting disks (26), wherein at least one of the supporting disks (26) on an axial side (27) facing the piston body (22) is constructed so as to be at least partially concavely curved, while the piston body (22) is convexly curved at least partially at an axial side (28) facing the at least one supporting disk (26).

18. The piston valve (21) according to claim 17, wherein the piston body (22) is axially penetrated by at least one passage having an orifice, said at least one passage can be covered with at least one valve disk at each said orifice.

19. The piston valve (21) according to claim 18, wherein said at least one passage can be covered at at least one of said orifice with a valve disk package (23).

20. The piston valve (21) according to claim 18, wherein said at least one valve disk contacts an intermediate disk (25) on a side remote of the piston body (22), said intermediate disk (25) extending radially over a portion of said at least one valve disk.

21. The vibration damper according to claim 19, wherein said piston valve (1) is a piston valve according to claim 18.

22. A method of assembling a vibration damper according to claim 20, comprising: initially sliding the compensating disk (20) and at least the immediately succeeding component of the piston valve (1) onto the piston rod neck (4) of the piston rod (2) against the contact shoulder (6);
subsequently tensioning the compensating disk (20) and the at last immediately succeeding component of the piston valve (11) with a preload against the contact shoulder (6), the preload being above a subsequent assembly pretensioning force; and
fastening the complete piston valve (1) to the piston rod neck (4) accompanied by pretensioning with the assembly pretensioning force.
